(19) United States
(12) Patent Application Publication
(10) Pub. No.: US 2010/0294575 A1
(43) Pub. Date: Nov. 25, 2010

(54) Motorized six wheel hand truck

(76) Inventor: Yvon Martel, Salaberry-De-Valleyfield (CA)

Correspondence Address: Yvon Martel, # 106, 3591 Gouin E., Montreal, QC, H1H 5V7, CA

(21) Appl. No.: 12/468,833

(22) Filed: May 19, 2009

(51) Int. Cl. B62D 57/024

(52) U.S. Cl. 180/8.2

(57) ABSTRACT

A motorized hand truck has six wheels around an axle. An electric motor, through a worm drive, drives a gear box connected to the axle. The hand truck can be used horizontally to carry long objects. It could be used to carry stretchers for example. In fact, for heavy object, using it horizontally is safer for the user who is below the load and controls it from a low center of gravity.

### FIELD OF THE INVENTION

The present invention relates generally to carrying equipment but more particularly to a motorized six wheel hand truck.

### BACKGROUND OF THE INVENTION

There exist unmotorized hand trucks having six wheels around one axle. They are use for carrying objects up or down stairs. While one pair of wheels (one at each side) is on one step, another pair of wheels touches the riser while the third pair is already on the above step. Pulling up on the hand truck provides for a smoother rise than with traditional two wheeled hand trucks. The same smooth motion also occurs while going down the stairs. There are also a variety of two wheeled motorized hand trucks designed for use on stairs. Some models have a piston like device which protracts so as to lift the hand truck up to the higher step or lower it to the lower step.

hand trucks of the prior art tend to be expensive, heavy and bulky. There is a need for better motorized hand trucks.

### SUMMARY OF THE INVENTION

In view of the foregoing disadvantages inherent in the known devices now present in the prior art, the present invention, which will be described subsequently in greater detail, is to provide objects and advantages which are:

To provide for a hand truck having the smooth ride of a 6 wheel hand truck with the advantage of being motorized so as to facilitate going up and down stairs.

Another advantage of this hand truck is that a cordless drill canbe used as the motor source so as to provide for a low cost and versatile hand truck.

It is another advantage of this hand truck to be used horizontally in tairs so that it can be used along with a gurney to carry patients.

To attain these ends, the present invention generally has a frame comprising at least one handle member located at one end of the frame; a support platform member located at an opposite end of the frame from the handle member; an axle member rotatably attached to the frame and located adjacent an end of the frame opposite form the one end of the frame; two wheel connector members releasably connected to each respective end of the axle member, each respective two wheel connector members having three equally spaced wheel attachment points and wheel members respectively rotatably attached to each of the wheel attachment points, thereby having three wheel members respectively and rotatably attached to respective ends of the axle member. A motor member attached to a portion of the frame and a worm gear mechanically attached to a gear and the gear mechanically attached to the axle member, to thereby mechanically rotate the axle member and wheel connectors.

The motor member attached to the worm gear mechanically attached to a gear and the gear mechanically attached to the axle member, to thereby mechanically rotate the axle member and wheel connectors.

The motor member, the worm gear, the round gear and the axle member are mechanically connected and always in contact with one another such that when the motor is stopped or reversed there is no displacement between members and thereby no mechanical backlash.

The connection between the motor member, the worm gear, and the axle member includes intermeshing gear teeth.

At least one handle member includes a control member that is connected to the motor member and controls the power and rotational direction of the motor member.

There are two handle members, each handle member including a control member that is connected to the motor member and together control the power and rotational direction of the motor member.

The wheel connector members are shaped such that when said motorized hand truck is used upon stairs and said wheel connector members rotate, they are adapted to easily move up and down each stair member. The wheel connector members are Y-shaped.

In a variation of the embodiment, the motor member can be replaced with a removable, reversible, and cordless drill.

In yet another variation, a gurney for transporting a patient can be attached to the hand truck so as to move a patient up and down stairs.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Isometric view of the invention.

FIG. 2 Exploded view of the drive system as it relates to the rest of the hand truck.

FIG. 3 Isometric view of the Invention when used in horizontal mode.

FIG. 4 Side cutaway view of the gear box.

FIG. 5 Side view of the invention when used with a gurney.

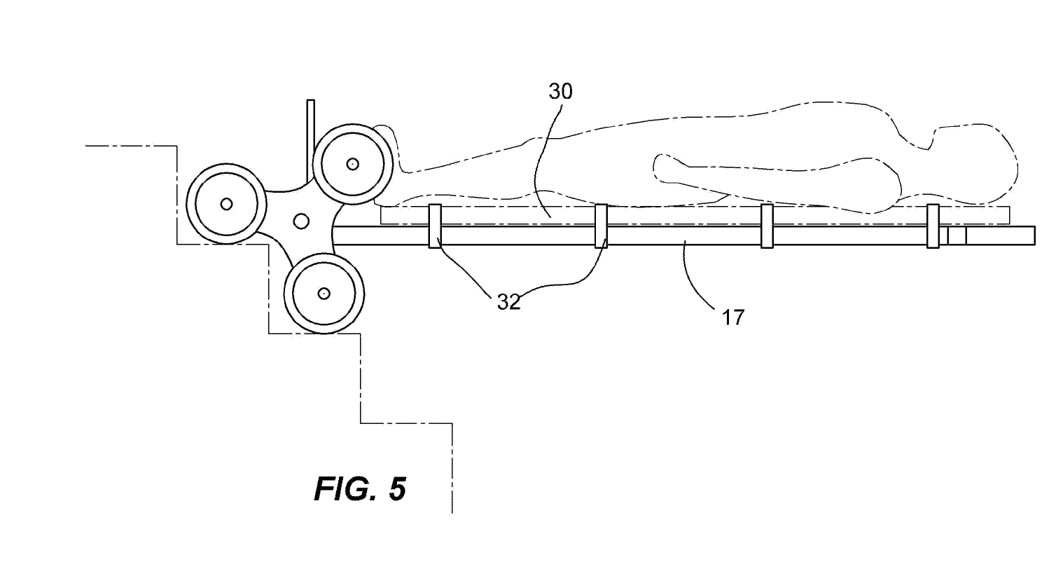

### DETAILED DESCRIPTION OF THE PREFERRED EMBODIMENT

A motorized hand truck (10) has a number of components found on regular hand trucks such as a frame (17). The frame (17) having an end of frame part (11) wherein handle members (21) are located and an opposite end of frame part (13) wherein a platform (15) is located.

The motorized hand truck (10) has six wheels (12) around an axle member (14). An electric motor (16), through a worm gear (21), drives a round gear (19) connected to the axle member(14). The worm gear (21) and the round gear (19) are both located inside a gear box (18). The motor (16) can turn in both direction and is actuated by hand controls (20). The motor (16) is preferably battery operated.

The worm gear (21) prevents the axle member (14) from moving when the motor (16) is not running. That way, the hand truck (10) will not accidentally roll downwards when climbing stairs since the worm gear (21) meshes in with the round gear (19) in such a way that when the motor (16) is stopped or reversed there is no displacement between the worm gear (21) and the gear (19) and thereby no mechanical backlash.

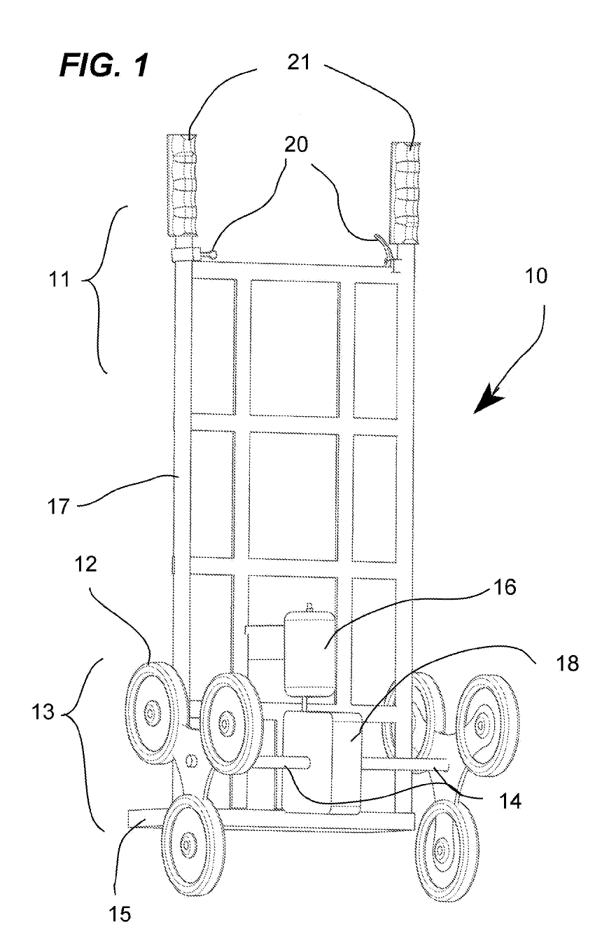

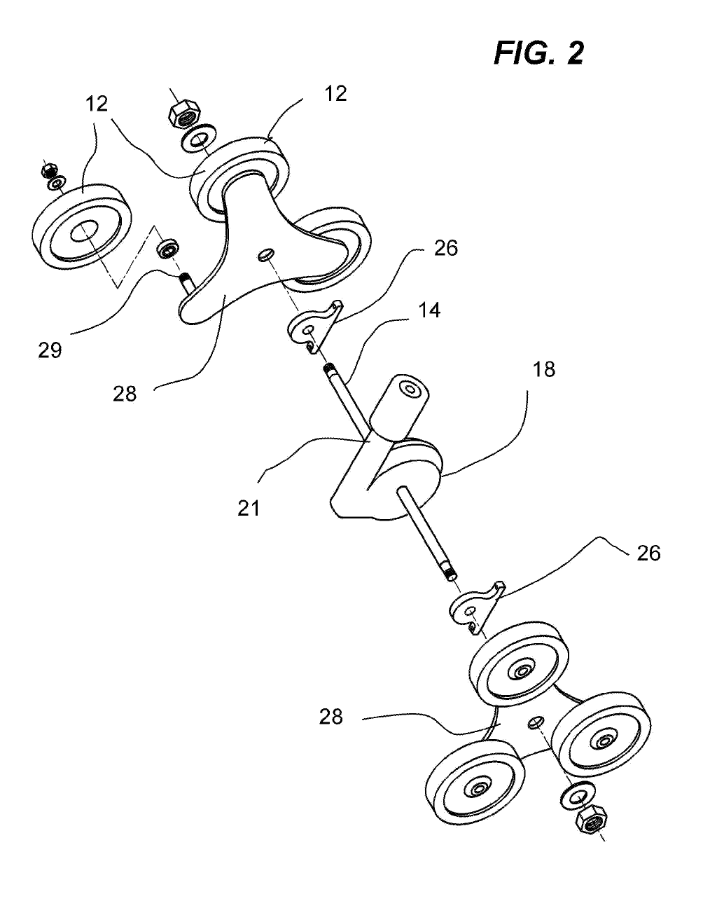

FIG. 2, shows the wheels (12) and axle member (14), with the motor (16) removed. The gear box (18) shape is irrelevant and two examples are shown in FIGS. 1 and 2. The axle member (21) connects with the wheel connector member (28) and the wheel connector member (28) connects to the wheel (12) by way of a wheel attachment point (29). Attachment brackets (26) attach the axle member (14) to the opposite end of frame (13).

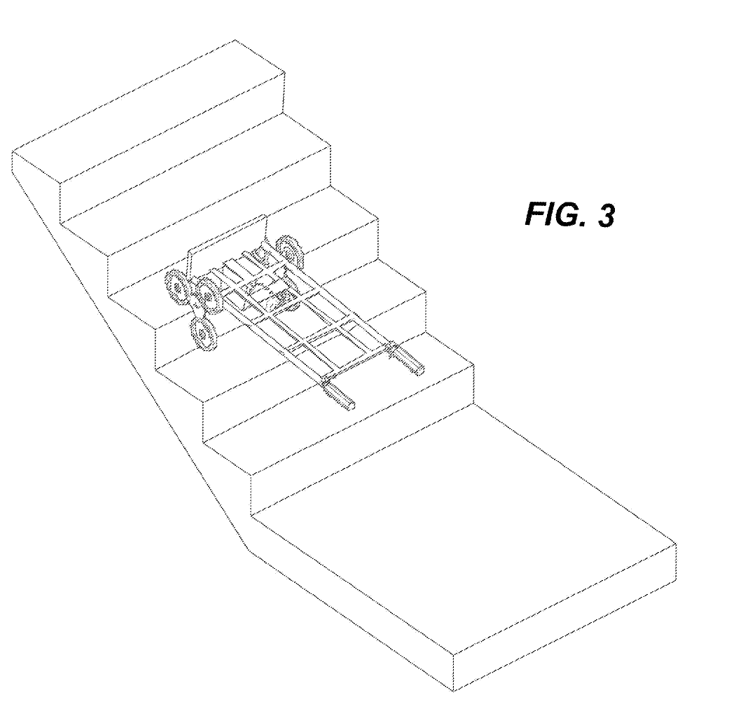

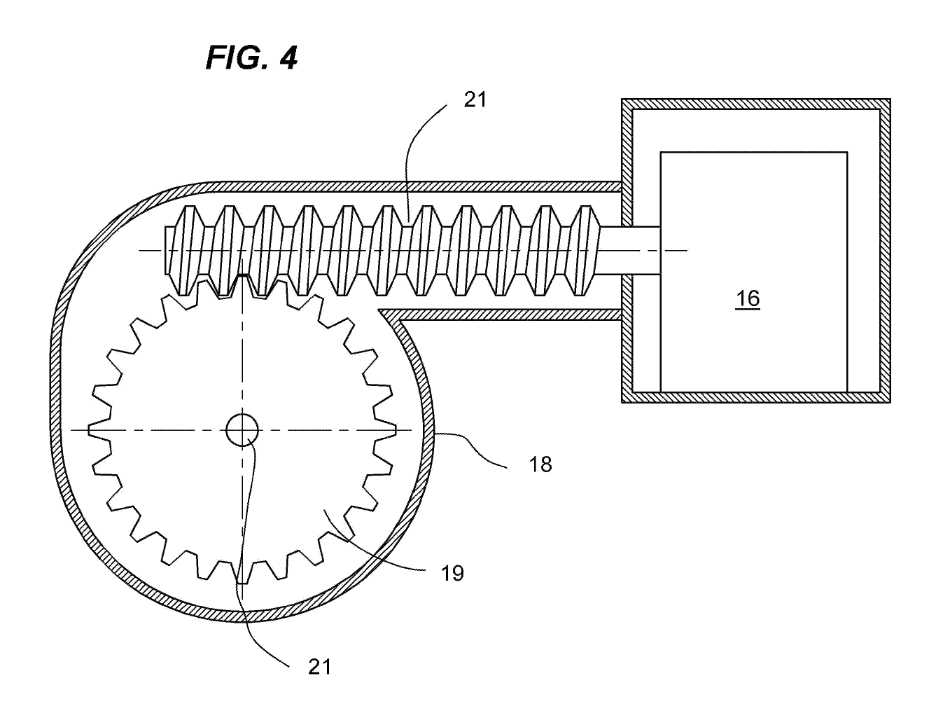

The hand truck (10) can be used horizontally to carry long objects. It could be used to carry a gurney (30) as seen in FIG. 4 for example. In fact, for heavy object, using it horizontally as per FIG. 3 is safer for the user who is below the load and controls it from a low center of gravity.

In the example of the gurney (30) attachment means (32) mechanically tie the gurney (30) to the frame (17). The attachment means (32) canbe in the form of straps or connecting brackets.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1.) A motorized hand truck comprising a frame comprising at least one handle member located at one end of said frame; a support platform member located at an opposite end of said frame from said handle member; an axle member rotatably attached to said frame and located adjacent said opposite end of said frame;
two wheel connector members connected to each respective end of said axle member, each respective said two wheel connector members having three equally spaced wheel attachment points and wheel members respectively rotatably attached to each of said wheel attachment points, thereby having three wheel members respectively and rotatably attached to respective ends of said axle member; a motor member attached to a portion of said frame; and a worm gear mechanically attached to said motor member and said motor member mechanically attached to a round gear and said round gear is attached to said axle member, to thereby mechanically rotate said axle member and wheel connectors.

2.) The motorized hand truck of claim 1, wherein said motor member is connected to said worm gear, and said worm gear is connected to said round gear and said round gear axle member; and wherein said motor member, said worm gear, said round gear, and said axle member are mechanically connected and always in contact with one another such that when the motor is stopped or reversed there is no displacement between members and thereby no mechanical backlash.

3.) The motorized hand truck of claim 2, wherein said connection between said motor member, said worm gear, said round gear,and said axle member includes intermeshing gear teeth.

4.) The motorized hand truck of claim 1, wherein said at least one handle member includes a control member that is connected to said motor member and controls the power and rotational direction of said motor member.

5.) The motorized hand truck of claim 1, wherein there are two handle members, each handle member including a control member that is connected to said motor member and together control the power and rotational direction of said motor member.

6.) The motorized hand truck of claim 1, wherein said wheel connector members are shaped such that when said motorized hand truck is used upon stairs and said wheel connector members rotate, they are adapted to easily move up and down each stair member.

7.) The motorized hand truck of claim 6, wherein said wheel connector members are Y-shaped.

8.) The motorized hand truck of claim 1, wherein said motor member is a removable, reversible, and cordless drill.

9.) A motorized hand truck for use upon stair members comprising a frame comprising at least one handle member located at one end of said frame; a support platform member located at an opposite end of said frame from said handle member; an axle member rotatably attached to said frame and located adjacent an end of said frame opposite form said one end of said frame; two wheel connector members releasably connected to each respective end of said axle member, each respective said two wheel connector members having three equally spaced wheel attachment points and wheel members respectively rotatably attached to each of said wheel attachment points, thereby having three wheel members respectively and rotatably attached to respective ends of said axle member; a motor member attached to a portion of said frame;
and a worm gear mechanically attached to said motor member and said motor member mechanically attached to a round gear and said round gear is attached to said axle member, to thereby mechanically rotate said axle and wheel connectors.

10.) The motorized hand truck of claim 9, wherein said wheel connector members are shaped such that when said motorized hand truck is used upon said stair members and said wheel connector members rotate, they are adapted to easily move up and down each stair member.

11.) The motorized hand truck of claim 10, wherein said wheel connector members are Y-shaped.

12.) A combination of a motorized hand truck for use upon stair members, and a gurney used for carrying hospital patients; the hand truck comprising a frame comprising at least one handle member located at one end of said frame; a support platform member located at an opposite end of said frame from said handle member; an axle member rotatably attached to said frame and located adjacent an end of said frame opposite form said one end of said frame; two wheel connector members releasably connected to each respective end of said axle member, each respective said two wheel connector members having three equally spaced wheel attachment points and wheel members respectively rotatably attached to each of said wheel attachment points, thereby having three wheel members respectively and rotatably attached to respective ends of said axle member; a motor member attached to a portion of said frame; and a worm gear mechanically attached to said motor member and said motor member mechanically attached to a round gear and said round gear is attached to said axle member, to thereby mechanically rotate said axle and wheel connectors; and wherein said gurney is adapted to fit upon said hand truck, such that said gurney and said hand truck together are adapted to traverse sets of stairs in both the upward or downward directions.

13.) The combination of claim 12, wherein said wheel connector members are shaped such that when said motorized hand truck is used upon said stair members and said wheel connector members rotate, they are adapted to easily move up and down each stair member.

14.) The combination of claim 13, wherein said wheel connector members are Y-shaped.
